(19) United States
(12) Patent Application Publication
(10) Pub. No.: US 2011/0263326 A1
(43) Pub. Date: Oct. 27, 2011

(54) PROJECTING AND CONTROLLING WAGERING GAMES

(75) Inventors: Mark B. Gagner, West Chicago, IL (US); Damon E. Gura, Chicago, IL (US); Larry J. Pacey, Northbrook, IL (US); James M. Rasmussen, Chicago, IL (US); Matthew J. Ward, Northbrook, IL (US)

(73) Assignee: WMS Gaming, Inc., Waukegan, IL (US)

(21) Appl. No.: 13/094,394

(22) Filed: Apr. 26, 2011

Related U.S. Application Data
(60) Provisional application No. 61/328,034, filed on Apr. 26, 2010.

(51) Int. Cl. A63F 13/00

(52) U.S. Cl. 463/34

(57) ABSTRACT

A wagering game system and its operations are described herein. In embodiments, the operations can include projecting an image of wagering game content onto a physical surface and controlling a wagering game, associated with the wagering game content, using player interaction with the image. The operations can further include modifying the image in response to the player interaction with the image. The operations can further include controlling the wagering game using physical objects in a physical environment around the image. The operations can also include modifying the image based on detected characteristics of the physical environment. The operations can further include modifying the image based on player-specific information.

### RELATED APPLICATIONS

This application claims the priority benefit of U.S. Provisional Application No. 61/328,034 filed Apr. 26, 2010.

### LIMITED COPYRIGHT WAIVER

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2011, WMS Gaming, Inc.

### TECHNICAL FIELD

Embodiments of the inventive subject matter relate generally to wagering game systems and networks that, more particularly, project and control wagering games.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE DRAWING(S)

Embodiments are illustrated in the Figures of the accompanying drawings in which:

FIG. 1 is an illustration of projecting and controlling wagering game content in a non-casino environment using gaming projection devices, according to some embodiments;

FIG. 2 is an illustration of projecting and controlling wagering game content in a casino environment using gaming projection devices, according to some embodiments;

FIG. 3 is an illustration of a wagering game system architecture 300, according to some embodiments;

FIG. 4 is a flow diagram 400 illustrating projecting and controlling a wagering game, according to some embodiments;

FIG. 5 is an illustration of a wagering game computer system 500, according to some embodiments;

FIG. 6 is an illustration of a personal wagering game system 600, according to some embodiments;

FIG. 7 is an illustration of a wagering game machine architecture 700, according to some embodiments; and

FIG. 8 is an illustration of a wagering game machine 800, according to some embodiments.

### DESCRIPTION OF ILLUSTRATIVE EMBODIMENTS

This description of the embodiments is divided into five sections. The first section provides an introduction to embodiments. The second section describes example operating environments while the third section describes example operations performed by some embodiments. The fourth section describes additional example operating environments while the fifth section presents some general comments.

### INTRODUCTION

This section provides an introduction to some embodiments.

Wagering game manufacturers produce large and complex wagering game machines, which casinos buy and place on casino floors. The wagering game machines include large and expensive hardware, such as high-definition displays, cash delivery machinery, tall exterior cabinets, etc., which can make them expensive to transport, set up, store, and maintain. Further, some wagering game manufacturers have begun to incorporate environmental gaming lights and sounds into a wagering game experience by turning on emotive lighting and generating surround sounds that can span across a room or casino. The casinos that utilize the environmental lighting from the wagering game manufacturers must also transport, set up, store and maintain the lighting hardware, which can become costly. Thus the large and expensive wagering game machines and the extensive lighting hardware, though capable of producing a very captivating gaming experience, are expensive and can require extensive setup, storage, or maintenance. Smaller venues, such as restaurants, bars, or other establishments, however, may desire to provide gaming without incurring high costs or without needing to perform extensive setup, storage, or maintenance of wagering game machines or environmental lighting. Some casinos may also desire a more compact and economical way of presenting wagering games.

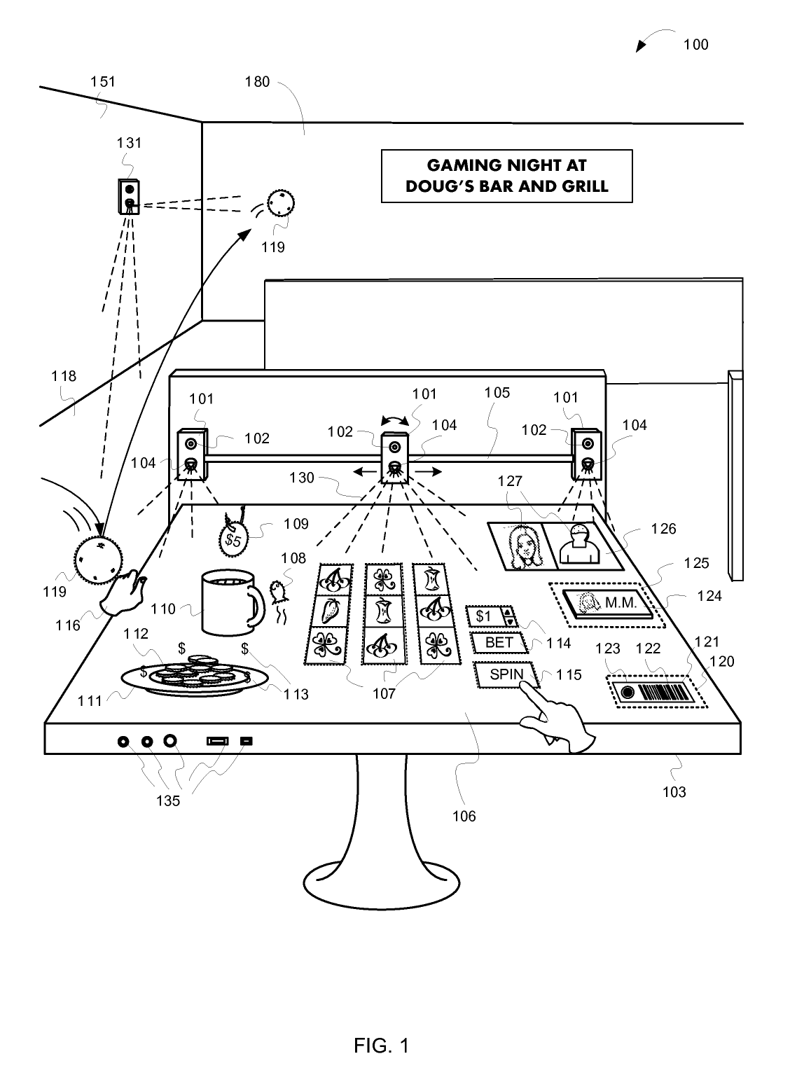

FIG. 1 is a conceptual diagram that illustrates an example of projecting and controlling wagering game content in a non-casino environment using gaming projection devices, according to some embodiments. In FIG. 1, a wagering game system (“system”) 100 includes gaming projection devices 101 configured to project, through the air, visible images of gaming content from a wagering game onto surfaces of a physical environment, such as a room or building at a geographic location (“location”) 180. One of the surfaces can be tabletop 106 of a table 103. The gaming content can include wagering game elements, which the gaming projection devices 101 project as virtual reels 107 for a slot game. The virtual reels 107 are not mechanical, but consist of a visible image of reel elements from the wagering game that are projected onto the tabletop 106. The tabletop 106, or anything on the tabletop 106 (e.g., silverware, tablecloths, player devices, etc.), reflect the visible image of the reel elements resulting in the virtual reels 107. The surface (e.g., the tabletop 106) does not need to be specially prepared to present the virtual reels 107, or any other content from the wagering game, although in some embodiments described further below, the system 100 can modify, or adapt, projected images to the materials, textures, or other characteristics of the surface or of physical objects on the surface. The gaming projection devices 101 can have projectors 104 and sensors, such as cameras 102. The projectors 104 can project beams 130, such as light beams, laser beams, infrared beams, or other forms of narrow, propagating streams of particles or energy. The surface (e.g., the tabletop 106) does not need to be a projection screen (although in some embodiments it can be) and the projected image does not have to travel through a specially prepared medium. Instead, the projectors 104 can project the beams 130 through air at normal atmospheric conditions (e.g., ground-level conditions, habitable conditions, tropospheric conditions, at or close to standard atmospheric conditions, etc.) onto any surface at the location 180 (e.g., the projectors 104 do not have to project the beams through a vacuum or through special gases, but can project the beams through breathable air at habitable atmospheric pressures and temperatures). The projectors 104 can modify the type or brightness of the beams 130 based on environmental conditions that exist in the normal atmosphere at the location 180 or on the characteristics of the wagering game content (e.g., project laser graphics using projection lasers to produce crisp images in brighter atmospheres, project video graphics using video projection lamps to produce images with multiple colors or shades, etc.).

The gaming projection devices 101 can detect player interaction with the virtual reels 107, or other projected images of gaming content. For example, the gaming projection devices 101 can project an image of a spin control (“virtual spin control”) 115 or project an image of a betting control (“virtual betting control”) 114. The gaming projection devices 101 can translate specific player motions (e.g., finger movements) that interact with the virtual spin control 115 or the virtual betting control 114 and use the player motions as player input. For instance, a player can tap his or her finger on the surface of the tabletop 106 at the location of the virtual spin control 115. The cameras 102 can detect and translate the tapping motion as an indication by the player that the gaming projection devices 101 (or server-based game controllers) should cause the virtual reels 107 to spin. The gaming projection devices 101 can then project an image of the virtual reels 107 in a spinning motion until the virtual reels 107 stop spinning and present a new image of the virtual reels 107. The new image of the virtual reels 107 presents a wagering game outcome for the slot game.

The gaming projection devices 101 can also include gaming controllers (e.g., a central processing unit) and gaming storage devices (e.g., memory). In some embodiments, the gaming projection devices 101 can be thin clients that receive content and control instructions from a server or central controller external to, but connected to, the gaming projection devices 101 via a communications network. For example, the gaming projection devices 101 can connect to a wagering game server associated with a wagering game provider

In some embodiments, the gaming projection devices 101 are compact, easily installable, and manually configurable. In some embodiments, the gaming projection devices 101 can be installed on or near the tabletop 106. For example, the gaming projection devices 101 can be installed using suction cups or using weighted mounting so that the gaming projection devices 101 can be portable. In some embodiments, the gaming projection devices 101 can be mounted to a structure or fixture near the table 103, such as to a wall 151. The gaming projection devices 101 can be connected to a track 105, which can electronically connect (e.g., via communication wires, via power wires, via wireless connection, etc.) to the gaming projection devices 101. The gaming projection devices 101 can also be manually configurable on the track 105. For instance, one or more of the gaming projection devices 101 can be manually moved along the track 105 or rotated. In some embodiments, the gaming projection devices 101 can present images on a single surface or across multiple surfaces. In other embodiments, the gaming projection devices 101 can be stored inside the table 103 and can emerge from the tabletop 106 when activated by the player or by a an individual local to the location 180. For example, a bartender or waiter can press a button and the gaming projection devices 101 can emerge from and/or submerge into the tabletop 106. When submerged, the gaming projection devices 101 can be covered with a protective cover for easy clean up of the tabletop 106.

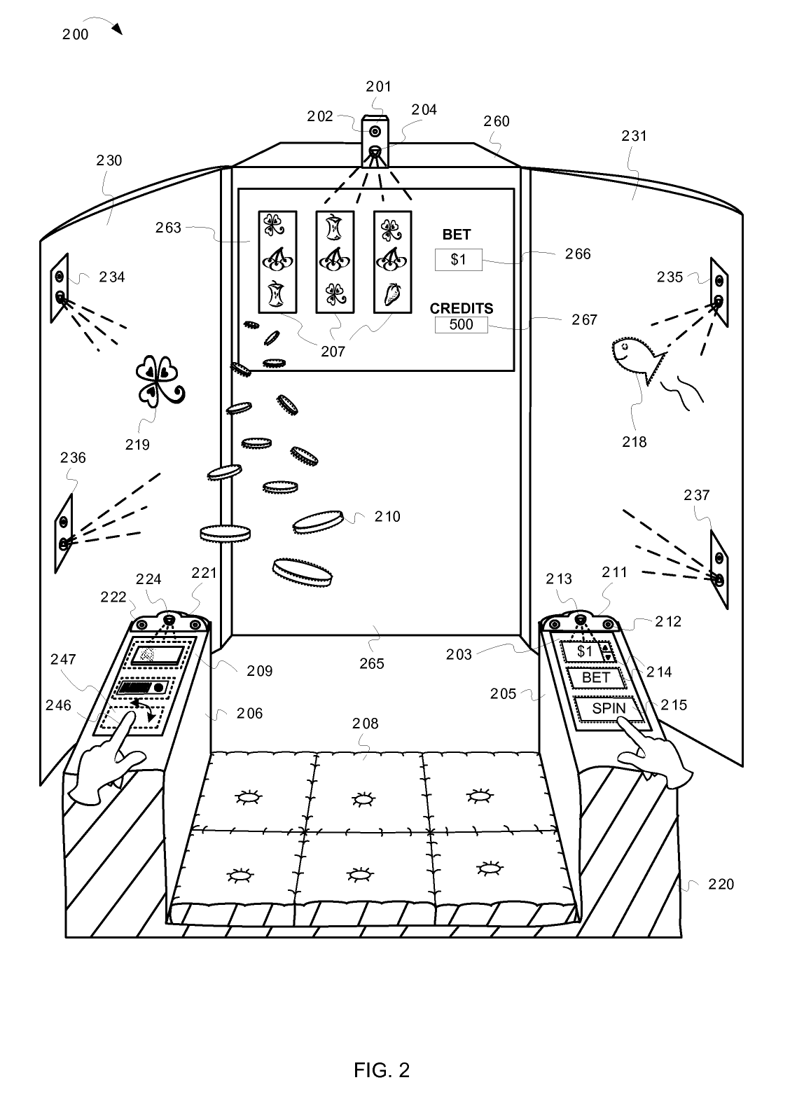

In some embodiments, such as in FIG. 1, the location 180 is not on a casino floor, but is in a restaurant, a bar, a private club, or another non-casino business establishment. In other embodiments, however, the gaming projection devices 101 can be in a casino, such as on, or in proximity to, a wagering game machine. FIG. 2 is a conceptual diagram that illustrates an example of projecting and controlling wagering game content in a casino environment using gaming projection devices, according to some embodiments. In FIG. 2, a wagering game system (“system”) 200 includes a wagering game machine 260 and a wagering game machine chair (“chair”) 220 in a casino. FIG. 2 presents a cut-away view of the chair 220 in front of the wagering game machine 260. The cut-away view intersects the chair 220 through the middle of a seat 208 and through the middle of two armrests 205 and 206. The perspective for the cut-away represents a player's perspective while sitting in the chair 220 or while standing behind the chair 220, but while facing the wagering game machine 260. The wagering game machine 260 presents reels 207 from a wagering game on a display 263. The reels 207 may be virtual projections (e.g., projected onto the front of the display 263 or from behind the display 263) but in some embodiments the reels 207 can be presented without projection. The wagering game machine 260 can also present a bet meter 266 and a credit meter 267, which track bets and credits won for the wagering game. One or more gaming projection devices 201, 234, 235, 236, and 237 are positioned on or near the wagering game machine 260. The gaming projection devices 201, 234, 235, 236, and 237 include projectors (e.g., projector 204) and sensors (e.g., camera 202). The projectors can project images from the wagering game on panels 230, 231 that flank and/or enclose the wagering game machine 260, on a casing, or cabinet 265 of the wagering game machine, and on the display 263. For example, the projectors project a virtual shamrock image 219 from the wagering game and a virtual fish image 218 from a long-standing fish-tank wagering game. The projectors can also project three-dimensional (3D) images, such as virtual coins 210, that are projected onto the display 263, on the cabinet 265, and on the panel 230 in a way that makes the coins appear to flow from one of the reels 207. The projectors project the virtual coins 210 with varying sizes from the perspective of a player sitting in the chair 220 so that the virtual coins 210 appear to be three-dimensional in shape. The projectors can project images that move and appear to flow, or move, into and out of the display 263. In some embodiments, the projectors can modify projected images in response to player input. For example, a player can hold out a bucket causing the virtual coins 210 to change their movement toward the bucket, or a player can aim a laser pointer at the virtual fish 218, causing the virtual fish 218 to move. In some embodiments, the chair 220 can include a touch panel 247 that a player can use to perform user input (e.g., touch with a finger 246) to move the images. In some embodiments, gaming projection devices 211 and 221 can be attached to, or associated with, the chair 220. Each armrest 205 and 206 of the chair 220 can respectively include the gaming projection devices 211 and 221. The gaming projection devices 211 and 221 can include projectors 213, 224 and sensors, such as cameras 212, 222. The projectors 213, 224 project images onto the armrests 205, 206. The images can be from the wagering game or related to the wagering game. For example, the projector 213 projects virtual betting controls 214 and a virtual spin control 215 downward onto a flat panel 203 built into the armrest 205. The camera 212 or other sensors (e.g., an infrared beam) captures player interaction with the virtual betting controls 214 and the virtual spin control 215, such as when a player taps a finger on the virtual spin control 215. The projector 224 can also project images onto a flat panel 209 of the armrest 206 and the camera 222, or other sensors, can detect player interaction with projected images on that armrest 206. In some embodiments, the projectors 213, 224 can be inside the armrests 205, 206 and can project upward onto a semi-transparent panel. In some embodiments, the projectors 213, 224 can project images onto a player sitting on the chair 220. The flat panels 203, 209 can also be retractable or otherwise configurable. In some embodiments, the chair 220 can include projectors that project from behind the player and onto the flat panels 203, 209, the panels 230, 231, the casing 265, the display 263, or any other surface in front of the chair 220.

Projections devices (e.g., gaming projection devices 201, 234, 235, 236, 237 or others not shown that may be attached to, inside of, or directed at the wagering game machine 260) can project button panels, or other graphics related to a wagering game, onto any surface on the wagering game machine 260, such as on surfaces on the front of the wagering game machine 260, which a user can access and use to control activity on the wagering game machine 260. For instance, in some embodiments, the system 200 can include panels, or other surfaces, on the front of the wagering game machine 260 in addition to, or instead of, on the chair 220. The system 200 can project game control buttons (e.g., spin controls, betting controls, game access controls, money input controls, etc.), or other graphics, onto the panels, or other surfaces, on the wagering game machine 260. In some embodiments, the projection devices project wagering game elements, controls, or other graphics, onto surfaces of the wagering game machine 260 other than onto mechanical reels within the display 263 of the wagering game machine 260.

In some embodiments, the system 200 can also project images onto an electronic gaming table (“e-table”), which is a type of wagering game machine at which multiple players can play a wagering game in a group (e.g., against each other, against the house, etc.). The system 200 can project images on a bezel of the e-table. The system 200 can project images of chips, cards, dice, or other content used while playing a wagering game at the e-table. The system 200 can project images on different sections or panels of the e-table or onto contours of the e-table. The system 200 can also add or remove player stations by projecting images that represent the player stations (e.g., button panels, card sections, betting sections, etc.).

Although FIGS. 1 and 2 describe some embodiments, other sections of this description describe many other features and embodiments. The other sections may occasionally refer back to FIGS. 1 and 2.

Further, some embodiments of the inventive subject matter can be presented over any type of communications network that provides access to wagering games, such as a public network (e.g., a public wide-area-network, such as the Internet), a private network (e.g., a private local-area-network gaming network), a file sharing network, a social network, etc., or any combination of networks. Multiple users can be connected to the networks via computing devices. The multiple users can have accounts that subscribe to specific services, such as account-based wagering systems (e.g., account-based wagering game websites, account-based casino networks, etc.).

Further, in some embodiments herein a user may be referred to as a player (i.e., of wagering games), and a player may be referred to interchangeably as a player account. Account-based wagering systems utilize player accounts when transacting and performing activities, at the computer level, that are initiated by players. Therefore, a “player account” represents the player at a computerized level. The player account can perform actions via computerized instructions. For example, in some embodiments, a player account may be referred to as performing an action, controlling an item, communicating information, etc. Although a player, or person, may be activating a game control or device to perform the action, control the item, communicate the information, etc., the player account, at the computer level, can be associated with the player, and therefore any actions associated with the player can also be associated with the player account. Therefore, for brevity, to avoid having to describe the interconnection between player and player account in every instance, a “player account” may be referred to herein in either context. Further, in some embodiments herein, the word “gaming” is used interchangeably with “gambling.”

### Example Operating Environments

This section describes example operating environments and networks and presents structural aspects of some embodiments. More specifically, this section includes discussion about wagering game systems and wagering game system architectures.

### Wagering Game System Architecture

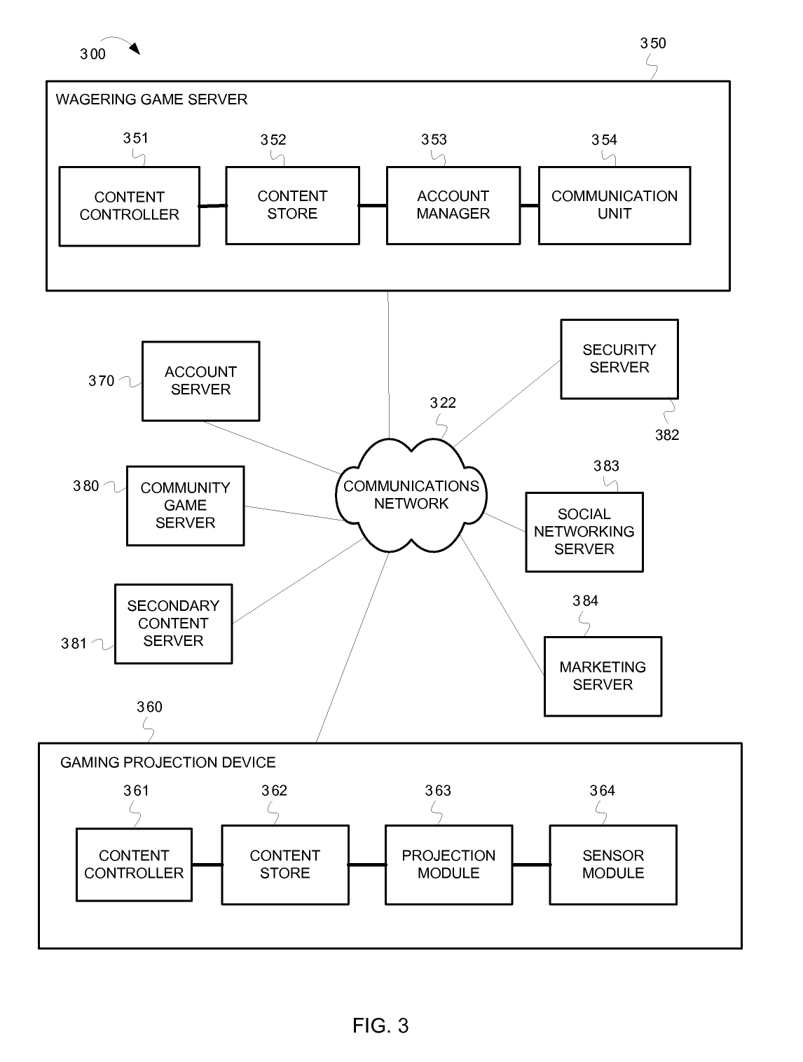

FIG. 3 is a conceptual diagram that illustrates an example of a wagering game system architecture 300, according to some embodiments. The wagering game system architecture 300 can include an account server 370 configured to control user related accounts accessible via wagering game networks and social networking networks. The account server 370 can store wagering game player account information, such as account settings (e.g., settings related to image projection and/or interaction with projected gaming images, settings related to group games, etc., settings related to social contacts, etc.), preferences (e.g., player preferences regarding projection of wagering game images, player preferences regarding award types, preferences related to virtual assets, etc.), player profile data (e.g., name, avatar, screen name, etc.), and other information for a player's account (e.g., financial information, account identification numbers, virtual assets, social contact information, etc.). The account server 370 can contain lists of social contacts referenced by a player account. The account server 370 can also provide auditing capabilities, according to regulatory rules. The account server 370 can also track performance of players, machines, and servers.

The wagering game system architecture 300 can also include a wagering game server 350 configured to control wagering game content, provide random numbers, and communicate wagering game information, account information, and other information to and from a gaming projection device 360. The wagering game server 350 can include a content controller 351 configured to manage and control content for the presentation of content via the gaming projection device 360. For example, the content controller 351 can generate game results (e.g., win/loss values), including win amounts, for games played via the gaming projection device 360. The content controller 351 can communicate the game results to the gaming projection device 360. The content controller 351 can also generate random numbers and provide them to the gaming projection device 360 so that the gaming projection device 360 can generate game results. The wagering game server 350 can also include a content store 352 configured to contain content to present via the gaming projection device 360. The wagering game server 350 can also include an account manager 353 configured to control information related to player accounts. For example, the account manager 353 can communicate wager amounts, game results amounts (e.g., win amounts), bonus game amounts, etc., to the account server 370. The wagering game server 350 can also include a communication unit 354 configured to communicate information to, and from, the gaming projection device 360 and to communicate with other systems, devices and networks.

The wagering game system architecture 300 can also include the gaming projection device 360 configured to present wagering games and receive and transmit information to project and control wagering games. The gaming projection device 360 can include or be associated with a computer system, a personal digital assistant (PDA), a cell phone, a laptop, a wagering game machine, or any other device or machine that is capable of processing information, instructions, or other data provided via a communications network 322. The gaming projection device 360 can include a content controller 361 configured to manage and control content and presentation of content via the gaming projection device 360. The gaming projection device 360 can also include a content store 362 configured to contain content to present via the gaming projection device 360. The gaming projection device 360 can also include a projection module 363 configured to project images onto surfaces (e.g., of physical objects) in projection distance to the gaming projection device. The gaming projection device 360 can also include a sensor module 364 configured to detect player input and environmental conditions in proximity to the gaming projection device 360.

The wagering game system architecture 300 can also include a community game server 380 configured to provide and control content for community games, including networked games, social games, competitive games, or any other game that multiple players can participate in at the same time.

The wagering game system architecture 300 can also include a secondary content server 381 configured to provide content and control information for secondary games and other secondary content (e.g., secondary wagering game content, promotions content, advertising content, player tracking content, web content, etc.). The secondary content server 381 can provide “secondary” content, or content for “secondary” games presented by the gaming projection device 360. “Secondary” in some embodiments can refer to an application's importance or priority of the data. In some embodiments, “secondary” can refer to a distinction, or separation, from a primary application (e.g., separate application files, separate content, separate states, separate functions, separate processes, separate programming sources, separate processor threads, separate data, separate control, separate domains, etc.). Nevertheless, in some embodiments, secondary content and control can be passed between applications (e.g., via application protocol interfaces), thus becoming, or falling under the control of, primary content or primary applications, and vice versa.

The wagering game system architecture 300 can also include a security server 382 configured to receive video footage or other images and signals from the gaming projection device 360 and monitor security for wagering games.

The wagering game system architecture 300 can also include a social networking server 383 configured to host social networking network accounts, provide social networking content, control social networking communications, store associated social contacts, etc. The social networking server 383 can also provide chat functionality for a social networking website, a chat application, or any other social networking communications mechanism.

The wagering game system architecture 300 can also include a marketing server 384 configured to utilize player data to determine marketing promotions that may be of interest to a player account. The marketing server 384 can also analyze player data and generate analytics for players, group players into demographics, integrate with third party marketing services and devices, etc. The marketing server 384 can also provide player data to third parties that can use the player data for marketing.

Each component shown in the wagering game system architecture 300 is shown as a separate and distinct element connected via the communications network 322. However, some functions performed by one component could be performed by other components. For example, the wagering game server 350 can also be configured to perform functions of the projection module 363, the sensor module 364, and other network elements and/or system devices. Furthermore, the components shown may all be contained in one device, but some, or all, may be included in, or performed by, multiple devices, as in the configurations shown in FIG. 3 or other configurations not shown. For example, the account manager 353 and the communication unit 354 can be included in the gaming projection device 360 instead of, or in addition to, being a part of the wagering game server 350. Further, in some embodiments, the gaming projection device 360 can determine wagering game outcomes, generate random numbers, etc. instead of, or in addition to, the wagering game server 350.

As mentioned previously, in some embodiments, the gaming projection device 360 can be associated with, or perform functions of, a wagering game machine. Examples of wagering game machines can include floor standing models, handheld mobile units, bar-top models, workstation-type console models, surface computing machines, etc. Further, wagering game machines can be primarily dedicated for use in conducting wagering games, or can include non-dedicated devices, such as mobile phones, personal digital assistants, personal computers, etc.

In some embodiments, the gaming projection device 360 and the wagering game server 350 work together such that the gaming projection device 360 can be operated as a thin, thick, or intermediate client. For example, one or more elements of game play may be controlled by the client (e.g., the gaming projection device 360) or the server (e.g., the wagering game server 350). Game play elements can include executable game code, lookup tables, configuration files, game outcomes, audio or visual representations of the game, game assets or the like. In a thin-client example, the wagering game server can perform functions such as determining game outcome or managing assets, while the clients can present a graphical representation of such outcome or asset modification to the user (e.g., player). In a thick-client example, the clients can determine game outcomes and communicate the outcomes to the wagering game server for recording or managing a player's account.

In some embodiments, either the client or the server can provide functionality that is not directly related to game play. For example, account transactions and account rules may be managed centrally (e.g., by the server or locally (e.g., by the client). Other functionality not directly related to game play may include power management, presentation of advertising, software or firmware updates, system quality or security checks, etc.

Furthermore, the wagering game system architecture 300 can be implemented as software, hardware, any combination thereof, or other forms of embodiments not listed. For example, any of the network components (e.g., the wagering game machines, servers, etc.) can include hardware and machine-readable storage media including instructions for performing the operations described herein. Machine-readable storage media includes any mechanism that stores information in a form readable by a machine (e.g., a wagering game machine, computer, etc.). For example, machine-readable storage media includes read only memory (ROM), random access memory (RAM), magnetic disk storage media, optical storage media, flash memory machines, etc. Some embodiments of the invention can also include machine-readable signal media, such as any media suitable for transmitting software over a network.

### Example Operations

This section describes operations associated with some embodiments. In the discussion below, some flow diagrams are described with reference to block diagrams presented herein. However, in some embodiments, the operations can be performed by logic not described in the block diagrams.

In certain embodiments, the operations can be performed by executing instructions residing on machine-readable storage media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform more or less than all the operations shown in any flow diagram.

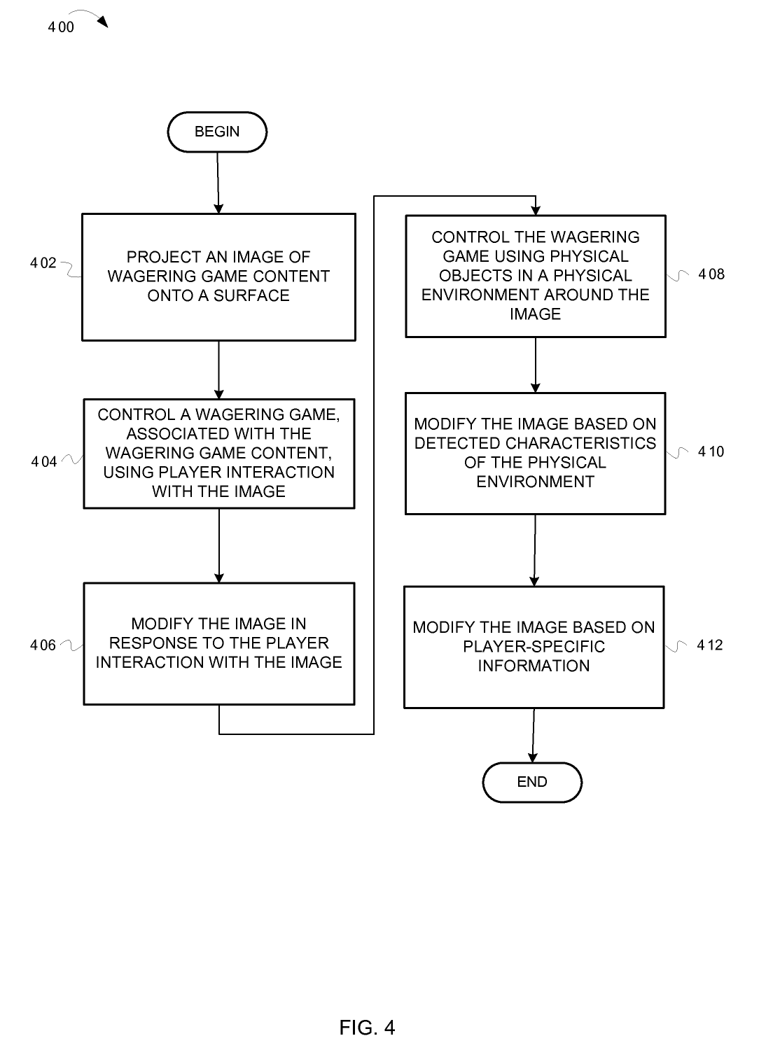

FIG. 4 is a flow diagram (“flow”) 400 illustrating projecting and controlling a wagering game, according to some embodiments. In some instances, this description will present FIG. 4 in concert with FIG. 1. In FIG. 4, the flow 400 begins at processing block 402, where a wagering game system (“system”) projects an image of wagering game content onto a physical surface (“surface”). The system can project images within a projection distance of a gaming projection device. The projection distance depends on the strength and focus of the beams that the projectors can project from the gaming projection device. The system can project movement of images between different surfaces, such as from a tabletop to a physical object on the tabletop or from a tabletop onto a wall. The system can also modify projected images based on a distance of a surface from the projector, based on a player's point of view or perspective, etc. The surface can be any surface that reflects a projection beam. The wagering game content can include any application or computerized object in, part of, or related to a wagering game, such as wagering game elements, player controls, animations, game characters, help files, player preferences, account settings, session balances, bet information, credits, etc.

As described further above, in FIG. 1, the gaming projection devices 101 project virtual reels 107, betting controls 114 and the spin control 115. In other examples, however, the gaming projection devices 101 also project a virtual fish 108 chasing a virtual coin 109 around a cup 110. The virtual fish 108 represents an avatar, or personal character, selected by a wagering game player to represent the player in a long-standing wagering game that runs while the wagering game player is not logged on to an account or accessing the long-standing wagering game. The gaming projection devices 101 can project the virtual fish 108 to replay an activity that the virtual fish 108 performed recently or is about to perform within the long-standing wagering game. The gaming projection devices 101 can project the virtual fish 108 swimming around the cup 110 or around any other physical object on the tabletop 106. The gaming projection devices 101 can also project congratulatory effects. In one example, the gaming projection devices 101 projects coins 112 and dollar signs 113 onto a plate 111 that rests on the tabletop 106 to represent a win that occurs during the slot game. In some embodiments, the gaming projection devices 101 can project images of other individuals (e.g., audience members, social contacts, friends, waiters, etc) that are participating in the wagering game (e.g., as part of a group wagering game, as part of a slot tournament, when performing side-bet wagers on the slot game, etc.), that are watching the game, or that are communicating with a player seated at the table 103. The gaming projection devices 101 can project images 127 of the individuals, such as a videos or camera feed images of the individuals, or avatars that represent the individuals. The gaming projection devices 101 can project the images 127 in a section 126 specifically designated for social communications. The gaming projection devices 101 and additional gaming projection devices (e.g., a gaming projection device 131 on a wall 151) can project images of group wagering game elements, such as a virtual cannon ball 119, that players can shoot at each other at the location 180. The gaming projection devices 101 and the gaming projection device 131 can project the virtual cannon ball 119 onto the wall 151, a floor 118, the tabletop 106, or any other surface at the location 180 to make the virtual cannon ball 119 appear to move throughout the location 180.

The flow 400 continues at processing block 404, where the system controls a wagering game, associated with the wagering game content, using player interaction with the image. In some embodiments, the system can detect player interaction with the image. For example, in some embodiments, the system can detect when the player touches (or performs other finger movements to) the surface within the boundaries of the image. In some embodiments, the system can include initialization requirements such as special finger motion patterns, a double-tap with an additional finger, a circle pattern with an additional finger, etc. In other example, the initialization requirements may include clicking a button with one finger, or placing one finger in one location, which indicates initialization then performing activities with another finger to indicate specific activities. Initialization requirements can ensure that the system detects only motions that the player intends to use for controlling the wagering game and can ignore finger motions that do not include the initialization motion.

In some embodiments, the system can detect finger movements using a camera. In some embodiments, the system can detect finger movements using an invisible infrared beam projected from an infrared projection device positioned above the surface onto which a gaming projection device projects an image. The infrared projection device can project the invisible infrared beam above the surface. The surface can be associated with a coordinates grid. When the player's finger makes movements on the surface, above projected images, the player's finger movements break the infrared beam at a specific location on the surface. The infrared light is reflected back to the infrared projection device. The reflected infrared beam passes through infrared filter to a camera, which photographs an angle of incoming infrared light. A sensor chip can determine where the infrared beam was broken in relation to the coordinates grid. The system then determines the coordinates associated with the location of the finger movements and determine actions to perform associated with the coordinates (e.g., if the coordinates coincide with the location of a virtual bet control, then the system can transact a bet). Some embodiments can perform optical analysis to analyze any type of motion or activity from a player. In some embodiments, the system can detect use, by a player, of handheld lasers, light beams, infrared beams, electromagnetic devices, etc. used instead of, or in conjunction with, finger motions to interaction with projected images.

In some embodiments, the system can control the wagering game using the player interaction. Some examples of controlling the wagering game may include, but are not limited to logging a player into a player account, transferring funds from a player's phone, transfer funds from a player account (e.g., financial account)., transacting a bet, activating game play (e.g., spinning reels, playing a hand of cards, etc.), and so forth.

The flow 400 continues at processing block 406, where the system modifies the image in response to the player interaction with the image. In some embodiments, the system can detect touches/finger motions of the player that indicate locations of where to move the projection (e.g., lock out sections) or of where to place certain projected images (e.g., player drags a net around their food, which contains a projection of an agent fish or animated avatar to a location around their food, or a player drags the playing elements of the wagering game to a plate on the table and restricts the location of the playing elements to the plate, etc.). In some embodiments, the system can use multiple projectors and/or cameras at different angles to detect multiple player touches at the same time and/or to increase accuracy of player touches.

In some embodiments, the system can detect group interaction with projected elements. For example, a projector can project an image of a gaming content object that multiple players can interact with and cause to move around a location (e.g., project a puck, a beach ball, etc. that people can hit around a room or project cannon balls that shoot between groups of players). For instance, referring momentarily to FIG. 1, a player uses their hand 116 to block the virtual cannon ball 119 from touching the tabletop 106, and directs the virtual cannon ball 119 to a different area of the location 180. Returning to FIG. 4, the system can use multiple camera's and/or gaming projection devices to stitch together the movement of the gaming content object. In some embodiments, the system can bounce the projection off of physical objects in the physical environment.

The flow 400 continues at processing block 408, where the system controls the wagering game using physical objects in a physical environment around the image. In some embodiments, the system can detect a location and/or placement of a physical object within a scanning proximity to a gaming projection device and then scan the physical object to determine physical characteristics of the physical object. In some embodiments, the physical characteristics can include identifying information that can be scanned using scanning sensors within the gaming projection device. The scanning sensors can use, for example, a laser beam, an infrared beam, an optical lens, a video lens, etc. In some embodiments, the system can scan characteristics of the physical object (e.g., identifying information) using the scanning sensors in the gaming projection device. Further the system can use the physical object or scanned characteristics (e.g., identifying information) to play a wagering game.

In some embodiments, the system can read and/or modify information from the physical objects. For example, in some embodiments, the system can project a bill/ticket validator or credit card scanner. In some embodiments, a player can place a specialized ticket in a specific location on a playing surface. The system can scan the specialized ticket and use financial information from the ticket during the wagering game. The system can also modify the ticket (e.g., write data to the ticket, invalidate a ticket number, etc.). For instance, in FIG. 1, the system 100 reads a ticket 121 within a ticket section 120. The ticket 121 can include identifying information, such as a barcode 122. In some embodiments, the system 100 can alter an image or print an image 123 on the ticket 121, using a projection laser, to indicate that the ticket 121 has been used or to change the ticket value. The ticket 121 does not have to include a printed value on it. One of the gaming projection devices 101 can project an image of a current value of the ticket 121 onto the ticket 121. In some embodiments, the system 100 can also read from and/or write to an e-paper ticket. In some embodiments, the system 100 can also include magnetic stripe readers and optic readers.

In some embodiments, the system 100 can scan information from a player's personal devices, such as scanning a screen on a smart phone, which shows a unique identification image, such as a barcode for a cash ticket, coupons codes for game discounts, player card identification codes, etc.

In some embodiments, the system 100 can read or modify information from player devices plugged into, or connected wirelessly to, a gaming projection device. For instance, the system 100 can include external connection jacks 135 to connect personal devices (e.g., a phone, a keyboard, a joystick, a laptop, etc.) to the system 100. The system 100 can read and write data to and from the personal device. For example, the gaming projection devices 101 can project a movie, or any other non-gaming content, onto the tabletop 106 using a movie file on a phone. In another example, the system 100 receives and uses data input via handheld controls or a keyboard on the personal device to control the slot game or other applications and functions. The personal device may include a projector (e.g., a mini-projector in a phone). The system can use the projector in the personal device instead of, or in addition to, the projectors 104 in the gaming projection devices 101. In some embodiments, the system 100 can automatically initiate a financial transaction of funds using the personal device as a proxy to make deposits to, or withdrawals from, a financial account. In some embodiments, the system 100 can use the personal device's processors for some gaming features. The system 100 can provide a software application to the personal device that would enable the device to receive, project, and control gaming content.

Returning to FIG. 4, in some embodiments, the system can detect movement or use of playing props on the playing surface, such as chips, game pieces, etc. In some embodiments, the system can also project images onto the prop objects.

In some embodiments, the system can perform security functions via gaming projection devices. For instance, in some embodiments, a camera on a gaming projection device can recognize an expected angle of access (e.g., determine an angle at which a player's hands are accessing the projection) and determine whether hands from unexpected angles of access are interfering (e.g., determine an angle from the side and ignore the access). In another example, the camera can perform head tracking to track where a player is looking or whether individuals are lurking or scoping out potential criminal activities. In some embodiments, the camera can look for a ring, bracelet, stamp, or other identifier on a player (e.g., can take a picture of the back of a player's hand and look for unique biometric identifiers on the hand, such as moles, marks, hand size, etc.). The system can use the identifiers to log in a player to a player account, lock out individuals who are not players, etc. In some embodiments, the system can read a unique image from a player's phone and provide access to a wagering game only if the phone is on and showing the unique image. In some embodiments, the system can provide a security camera feed to a security booth or desk when the player is playing.

In some embodiments, the system can detect visual images on and/or movement of a player card. For instance, in FIG. 1, the system 100 includes a player card section 125 where a player can place a player card 124. The player can pick the player card 124 up and down. The system 100 can sense the up and down movement of the player card 124 and control logging in and logging off or turning on and turning off of the gaming projection devices 101 accordingly. In some embodiments, the system 100 can read an infrared pattern on the player card 124 and use data from the infrared pattern to identify the player or obtain other information about the player (e.g., player history, player status, player loyalty points, player account balance, etc.). In some embodiments, the system 100 can detect when a friend places a second player card next to the player card 124. The system can then make side bets for the friend based on activity made by the player to whom the player card 124 belongs. The system can also link player accounts associated with the player and the friend and take a portion of a bet from each player account. The system can also follow the movement of the player card 124 to move the location of the projection (e.g., the device automatically updates the location of a projected image relative to where the player card 124 is located on the table-top 106).

Returning to FIG. 4, the flow 400 continues at processing block 410, where the system modifies the image based on detected characteristics of the physical environment. In some embodiments, the system can automatically adjust the image to adapt to physical characteristics of the surface. For example, the system can detect (e.g., take a picture of) groves or patterns on the surface (e.g., wood grain, woven patterns, etc.) and automatically adjust brightness or contrast of parts of the image to compensate for contrast differences that the groves cause to visible light projected, or beamed, from a gaming projection device. In some embodiments, the system can detect a surface color and change projection quality for better contrast with the surface color.

In some embodiments, the system can automatically modify projection imagery based on physical objects on the surface. For example, referring momentarily to FIG. 1, the system 100 can detect the position of the cup 110 on the tabletop 106, detect physical characteristics of the cup 110 (e.g. its height, length, its circumference, etc.), and automatically project the images of the virtual fish 108 chasing the virtual coin 109 around the cup 110 using the physical characteristics of the cup 110 to control the projection. In some embodiments, the system 100 can automatically detect a movement, a shift in position, a change in orientation, a change in physical composition, etc. of a surface or physical object and adjust a projection of an image accordingly. For example if the player moves the cup 110, then, in response, the system 100 can move the projection of the virtual fish 108 and the virtual coin 109 to the new position of the cup 110. In another example, the system 100 can monitor the amount of liquid in the cup 110. If the player drinks from the cup 110, then the system 100 can cause the fish to swim faster or slower, thus encouraging the player to drink more or less of the liquid from the cup 110.

Returning now to FIG. 4, in some embodiments, the system can project virtual characteristics onto a physical object. For example, in some embodiments, the system can use multiple projectors to create three-dimensional effects, such as a first projector to project textures, skins, highlights, mid-tones, etc. of an image on a physical object's surface and a second projector to project shadows or shading of the image on the same physical object's surface (e.g., one projector projects clothing detail, and another projects shading for clothing based on three-dimensional factors).

In some embodiments, the system can automatically modify projection quality or imagery based on environmental condition. For example, the system can project an image from a wagering game onto a surface, detect a condition of the environment that affects the quality of the image, and automatically adjust the projected image to adapt to the condition. Specifically, in one example, the system can automatically modify projection quality based on lighting characteristics of the physical environment. The system can increase or decrease power or brightness of a projection as the lighting increases or decreases in the physical environment.

The flow 400 continues at processing block 412, where the system modifies the image based on player-specific information. In some embodiments, the system can project an image from a wagering game onto a surface, and detect an event or condition of a wagering game (e.g., a state of play, a characteristic of a game feature or outcome, a gaming behavior, an amount of money won during the wagering game, etc.). The system can further detect an indication of preference by the player for the event or condition (e.g., a preference setting, a touching of a projected gaming content object, etc.). The system can then cause a characteristic of the image to be more prominent on the surface in response to the detecting the indication of preference. For example, the system can increase the image's brightness, change the image's size, move the image, etc.

In some embodiments, the system can modify the size of a projected image based on a calculated estimate of a player's potential interest in the projected image. For instance, the system can read from preference settings as described above and adapt the size of the projected image according to a scale of preference indicated by the player. In another embodiment, the system can refer to size scaling rules that indicate criteria about the event or condition that causes, or is related to, the projected image. For example, the system can detect that a long-standing wagering game character has won the player a prize with a large value. The system can refer to the size scaling rules and determine that a specific amount of value (e.g., points, money, privileges, etc.) won by a long-standing wagering game character warrants a specific size increase to the projection of the character in proportion to sizes of projections of other gaming content objects. For instance, the system can increase a size of a virtual fish that has recently eaten a large coin more than projections of virtual trophies that are indicated as having lower values in the size scaling rules.

In some embodiments, the system can modify content of projections based on player information. For example, the system can modify content based on player information stored in, or associated with, a player account or an establishment account. For example, the system can detect that a player accesses a wagering game player account via a gaming projection device, and the system can automatically present projections of the player's trophies, replays of the player's past games, replays of friends' games, etc. In some embodiments, the system can modify projections of food menus, advertising, special effects, etc. based on player preferences.

In some embodiments, the system can modify content based on a player's activity in the physical environment. For example, the system can detect activity of a player and determine when to present marketing. In another example, the system can detect an amount of alcohol consumed by a player (e.g., watch the number of drinks and/or drink level of a drink, such as in a section indicated by player for drinks) and provide content based on that and other player information (e.g., present a game where a player can guess an estimated blood alcohol level for the player or other's at the table based on number of drinks, persons' weight, amount of food consumed at the station, etc. all as observed by the gaming projection device's cameras or other detectors).

In some embodiments described herein, the system modifies presentation of wagering game content. In some embodiments, modifying presentation of wagering game content can include presenting a second, or additional, wagering game content that appears or behaves differently from a first wagering game content.

### Additional Example Operating Environments

This section describes example operating environments, systems and networks, and presents structural aspects of some embodiments.

### Wagering Game Computer System

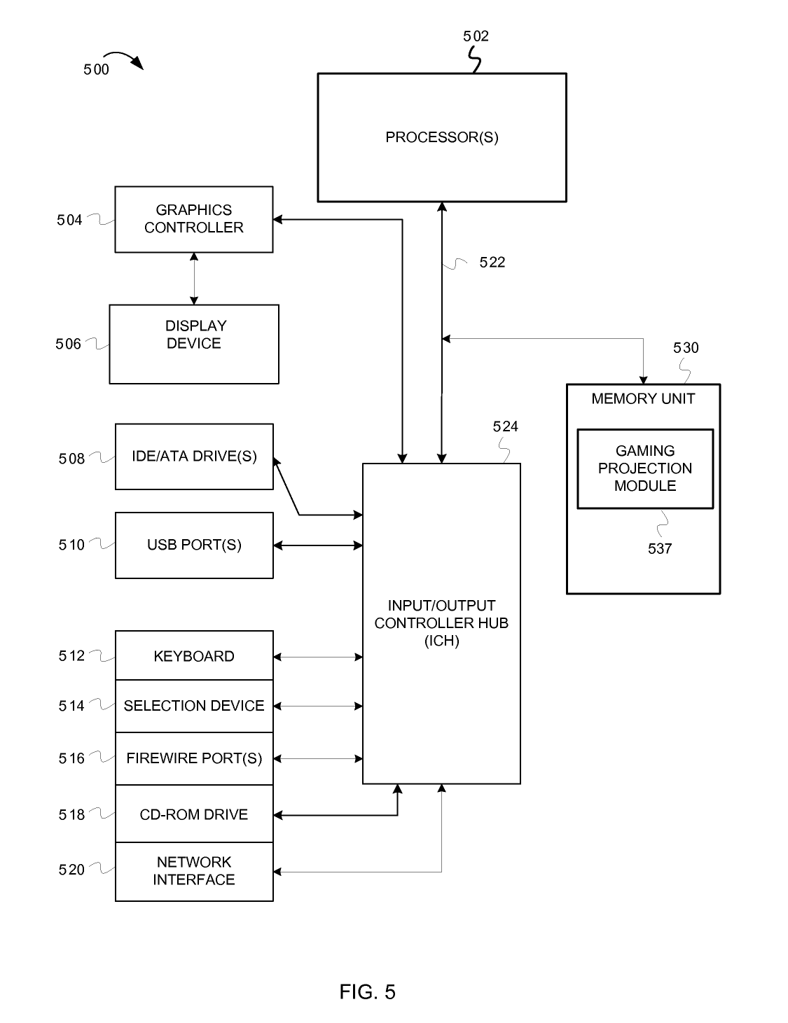

FIG. 5 is a conceptual diagram that illustrates an example of a wagering game computer system 500, according to some embodiments. In FIG. 5, the wagering game computer system (“computer system”) 500 may include a processor unit 502, a memory unit 530, a processor bus 522, and an Input/Output controller hub (ICH) 524. The processor unit 502, memory unit 530, and ICH 524 may be coupled to the processor bus 522. The processor unit 502 may comprise any suitable processor architecture. The computer system 500 may comprise one, two, three, or more processors, any of which may execute a set of instructions in accordance with some embodiments.

The memory unit 530 may also include an I/O scheduling policy unit and I/O schedulers. The memory unit 530 can store data and/or instructions, and may comprise any suitable memory, such as a dynamic random access memory (DRAM), for example. The computer system 500 may also include one or more suitable integrated drive electronics (IDE) drive(s) 508 and/or other suitable storage devices. A graphics controller 504 controls the display of information on a display device 506, according to some embodiments.

The input/output controller hub (ICH) 524 provides an interface to I/O devices or peripheral components for the computer system 500. The ICH 524 may comprise any suitable interface controller to provide for any suitable communication link to the processor unit 502, memory unit 530 and/or to any suitable device or component in communication with the ICH 524. The ICH 524 can provide suitable arbitration and buffering for each interface.

For one embodiment, the ICH 524 provides an interface to the one or more IDE drives 508, such as a hard disk drive (HDD) or compact disc read only memory (CD ROM) drive, or to suitable universal serial bus (USB) devices through one or more USB ports 510. For one embodiment, the ICH 524 also provides an interface to a keyboard 512, selection device 514 (e.g., a mouse, trackball, touchpad, etc.), CD-ROM drive 518, and one or more suitable devices through one or more firewire ports 516. For one embodiment, the ICH 524 also provides a network interface 520 though which the computer system 500 can communicate with other computers and/or devices.

The computer system 500 may also include a machine-readable storage medium that stores a set of instructions (e.g., software) embodying any one, or all, of the methodologies for project and control wagering games. Furthermore, software can reside, completely or at least partially, within the memory unit 530 and/or within the processor unit 502. The computer system 500 can also include a gaming projection module 537. The gaming projection module 537 can process communications, commands, or other information, to project and control wagering games. Any component of the computer system 500 can be implemented as hardware, firmware, and/or machine-readable storage media including instructions for performing the operations described herein.

### Personal Wagering Game System

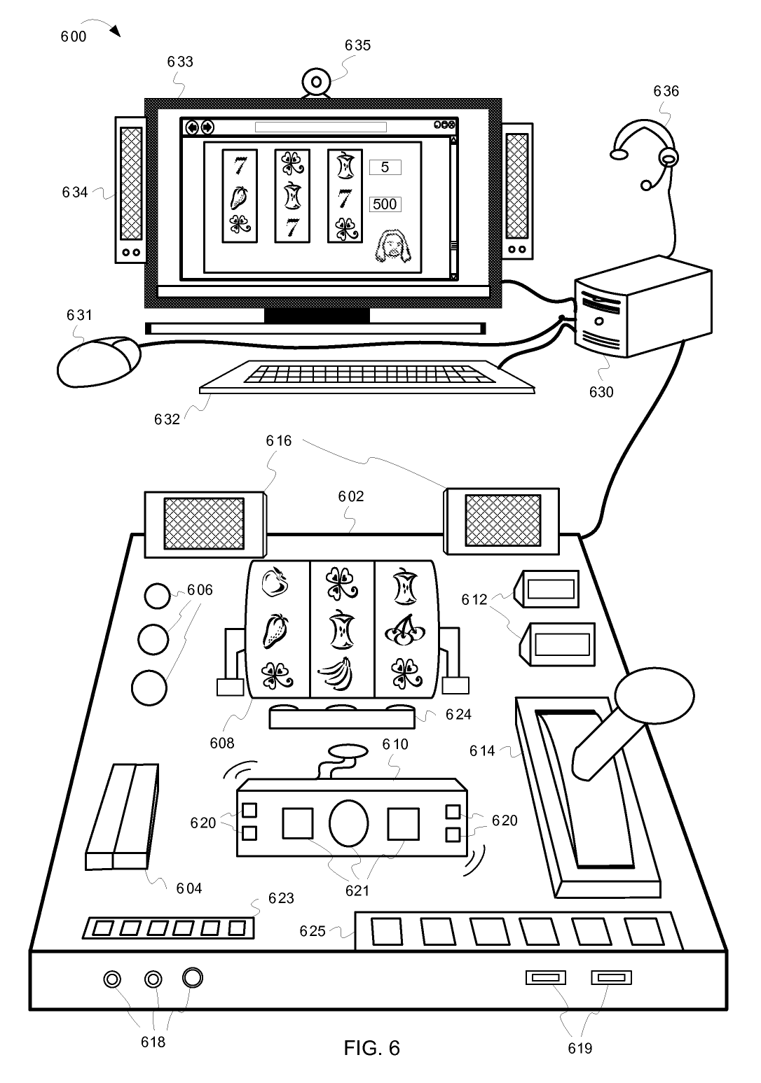

FIG. 6 is a conceptual diagram that illustrates an example of a personal wagering game system 600, according to some embodiments. In FIG. 6, the personal wagering game system (“system”) 600 includes an exemplary computer system 630 connected to several devices, including user input devices (e.g., a keyboard 632, a mouse 631), a web-cam 635, a monitor 633, speakers 634, and a headset 636 that includes a microphone and a listening device. In some embodiments, the webcam 635 can detect fine details of a person's facial features, from an eye-level perspective. The web-cam 635 can use the fine detail to determine a person's identity, their demeanor, their facial expressions, their mood, their activities, their eye focus, etc. The headset 636 can include biometric sensors configured to detect voice patterns, spoken languages, spoken commands, etc. The biometric sensors in the web-cam 635 can detect colors (e.g., skin colors, eye colors, hair colors, clothing colors, etc.) and textures (e.g., clothing material, scars, etc.). The biometric sensors in the web-cam 635 can also measure distances between facial features (e.g., distance between eyes, distance from eyes to nose, distance from nose to lips, length of lips, etc.). The system 600 can generate a facial and body map using the detected colors, textures, and facial measurements. The system 600 can use the facial and body map to generate similar facial features and body appearances for a player account avatar. Also connected to the computer system 630 is a gaming control device (“gaming pad”) 602 including wagering game accoutrements associated with wagering games. The wagering game accoutrements include one or more of prop reels 608, prop game meters 612, indicators 606, a game control device 610, a physical lever 614, a magnetic card reader 604, a video projection device 624, input/output ports 618, USB ports 619, and speakers 616. The gaming pad 602 can present feedback of online activities. For instance, the gaming pad 602 can use vibrations and signals on the gaming control device (e.g., the game control device 610 or the physical lever 614 can vibrate to indicate a back pat from another player or a game celebration, the indicators 606 can blink, etc.). The physical lever 614 can produce feelings in the lever to emulate a pulling feel or a vibration. The video projection device 624 can project video onto the prop reels 608 so that the prop reels 608 can present many different types of wagering games. The prop reels 608 can spin when the physical lever 614 is pulled. The video projection device 624 can project reel icons onto the prop reels 608 as they spin. The video projection device 624 can also project reel icons onto the prop reels 608 when the prop reels 608 are stationary, but the imagery from the video project device 624 makes the prop reels 608 appear to spin. In some embodiments, however, the prop reels 608 may be replaced with a projector screen or may be gone and the video projection device 624 can project onto a wall or other surface. In some embodiments, the video projection device 624 is a gaming projection device similar to those described in FIGS. 1 through 4 above. Further, the video projection device 624 can project images onto other parts of the gaming pad 602.

The magnetic card reader 604 can be used to swipe a credit card, a player card, or other cards, so that the system can quickly get information. The system 600 can offer lower rates for using the magnetic card reader 604 (e.g., to get a lower rate per transaction). The game control device 610 can include an emotion indicator keypad with keys 620 that a player can use to indicate emotions. The game control device 610 can also include biometric devices 621 such as a heart-rate monitor, an eye pupil dilation detector, a fingerprint scanner, a retinal scanner, voice detectors, speech recognition microphones, motion sensors, sound detectors, etc. The biometric devices 621 can be located in other places, such as in the headset 636, within a chair (not shown), within personal control devices (e.g. joysticks, remote controls, game pads, roller-balls, touch-pads, touch-screens, etc.), within the web-cam 635, or any other external device. The external devices can be connected to the computer 630 or to the game control device 610 via the input/output ports 618. As a security feature, some biometric devices can be associated with some of the gaming pad devices (e.g., the magnetic card reader 604), such as a fingerprint scanner, a retinal scanner, a signature pad to recognize a player's signature, etc. The game control device 610 can also use the keys 620 to share items and control avatars, icons, game activity, movement, etc. within a network wagering venue. The game pad can also have an electronic (e.g., digital) button panel 625, an electronic control panel 623, or any other type of changeable panel that can change appearance and/or configuration based on the game being played, the action being performed, and/or other activity presented within an online gaming venue. The game control device 610 can also move in different directions to control activity within the online gaming venue (e.g., movement of a player's avatar moves in response to the movements of the game control device 610). Avatars can be pre-programmed to act and look in certain ways, which the player can control using the system 600. The gaming pad 602 can permit the player to move the avatar fluidly and more easily than is possible using a standard keyboard. The system 600 can cause an avatar to respond to input that a player receives via the gaming pad 602. For example, a player may hear a sound that comes primarily from one direction (e.g., via stereophonic signals in the headset 636) within the network wagering venue. The system 600 can detect the movement of the player (e.g., the system 600 detects that a player moves his head to look in the direction of the sound, the player uses the game control device 610 to move the avatar's perspective to the direction of the sound, etc.). The system 600 can consequently move the avatar's head and/or the avatar's perspective in response to the player's movement. The player can indicate an expression of an emotion indicated by the player using the keys 620. The system 600 can make the avatar's appearance change to reflect the indicated emotion. The system 600 can respond to other movements or actions by the player and fluidly move the avatar to respond. The system 600 can also interpret data provided by the biometric devices and determine expressions and/or indications of emotions for a player using the system 600.

### Wagering Game Machine Architecture

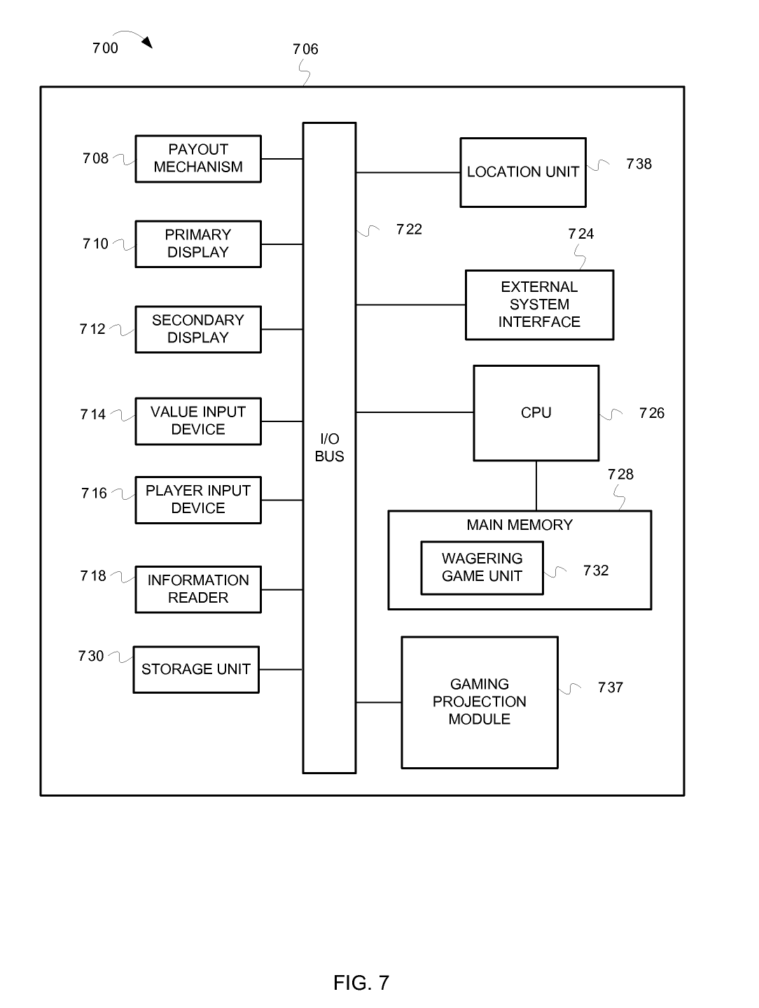

FIG. 7 is a conceptual diagram that illustrates an example of a wagering game machine architecture 700, according to some embodiments. In FIG. 7, the wagering game machine architecture 700 includes a wagering game machine 706, which includes a central processing unit (CPU) 726 connected to main memory 728. The CPU 726 can include any suitable processor, such as an Intel® Pentium processor, Intel® Core 2 Duo processor, AMD Opteron™ processor, or UltraSPARC processor. The main memory 728 includes a wagering game unit 732. In some embodiments, the wagering game unit 732 can present wagering games, such as video poker, video black jack, video slots, video lottery, reel slots, etc., in whole or part.

The CPU 726 is also connected to an input/output (“I/O”) bus 722, which can include any suitable bus technologies, such as an AGTL+frontside bus and a PCI backside bus. The I/O bus 722 is connected to a payout mechanism 708, primary display 710, secondary display 712, value input device 714, player input device 716, information reader 718, and storage unit 730. The player input device 716 can include the value input device 714 to the extent the player input device 716 is used to place wagers. The I/O bus 722 is also connected to an external system interface 724, which is connected to external systems (e.g., wagering game networks). The external system interface 724 can include logic for exchanging information over wired and wireless networks (e.g., 802.11g transceiver, Bluetooth transceiver, Ethernet transceiver, etc.)

The I/O bus 722 is also connected to a location unit 738. The location unit 738 can create player information that indicates the wagering game machine's location/movements in a casino. In some embodiments, the location unit 738 includes a global positioning system (GPS) receiver that can determine the wagering game machine's location using GPS satellites. In other embodiments, the location unit 738 can include a radio frequency identification (RFID) tag that can determine the wagering game machine's location using RFID readers positioned throughout a casino. Some embodiments can use GPS receiver and RFID tags in combination, while other embodiments can use other suitable methods for determining the wagering game machine's location. Although not shown in FIG. 7, in some embodiments, the location unit 738 is not connected to the I/O bus 722.

In some embodiments, the wagering game machine 706 can include additional peripheral devices and/or more than one of each component shown in FIG. 7. For example, in some embodiments, the wagering game machine 706 can include multiple external system interfaces 724 and/or multiple CPUs 726. In some embodiments, any of the components can be integrated or subdivided.

In some embodiments, the wagering game machine 706 includes a gaming projection module 737. The gaming projection module 737 can process communications, commands, or other information, where the processing can project and control wagering games.

Furthermore, any component of the wagering game machine 706 can include hardware, firmware, and/or machine-readable storage media including instructions for performing the operations described herein.

### Wagering Game Machine

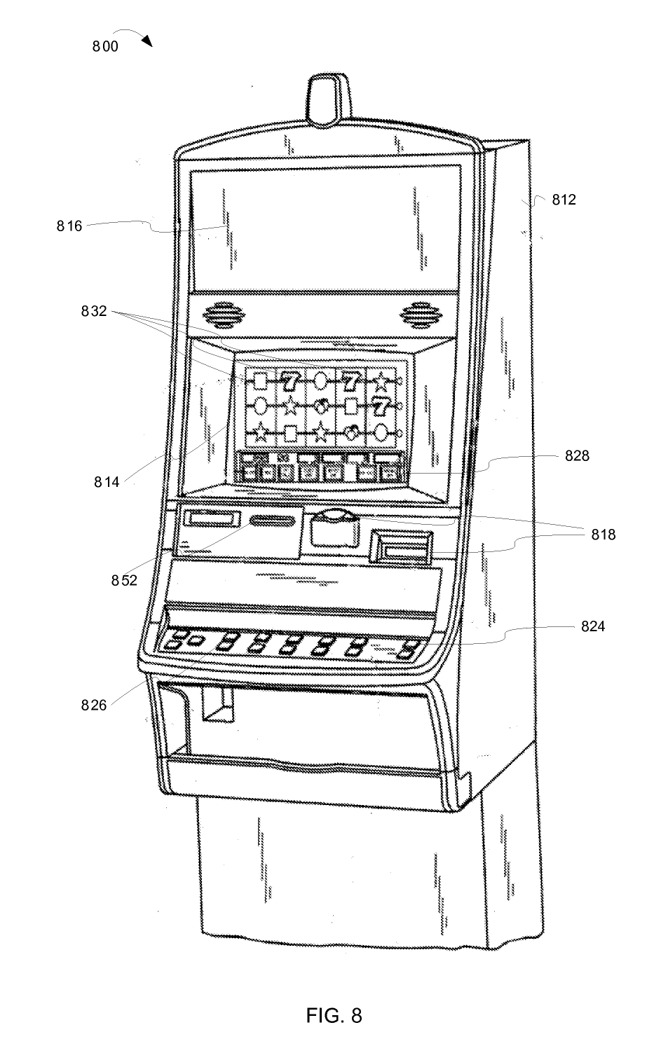

FIG. 8 is a conceptual diagram that illustrates an example of a wagering game machine 800, according to some embodiments. Referring to FIG. 8, the wagering game machine 800 can be used in gaming establishments, such as casinos. According to some embodiments, the wagering game machine 800 can be any type of wagering game machine and can have varying structures and methods of operation. For example, the wagering game machine 800 can be an electromechanical wagering game machine configured to play mechanical slots, or it can be an electronic wagering game machine configured to play video casino games, such as blackjack, slots, keno, poker, blackjack, roulette, etc.

The wagering game machine 800 comprises a housing 812 and includes input devices, including value input devices 818 and a player input device 824. For output, the wagering game machine 800 includes a primary display 814 for displaying information about a basic wagering game. The primary display 814 can also display information about a bonus wagering game and a progressive wagering game. The wagering game machine 800 also includes a secondary display 816 for displaying wagering game events, wagering game outcomes, and/or signage information. While some components of the wagering game machine 800 are described herein, numerous other elements can exist and can be used in any number or combination to create varying forms of the wagering game machine 800.

The value input devices 818 can take any suitable form and can be located on the front of the housing 812. The value input devices 818 can receive currency and/or credits inserted by a player. The value input devices 818 can include coin acceptors for receiving coin currency and bill acceptors for receiving paper currency. Furthermore, the value input devices 818 can include ticket readers or barcode scanners for reading information stored on vouchers, cards, or other tangible portable storage devices. The vouchers or cards can authorize access to central accounts, which can transfer money to the wagering game machine 800.

The player input device 824 comprises a plurality of push buttons on a button panel 826 for operating the wagering game machine 800. In addition, or alternatively, the player input device 824 can comprise a touch screen 828 mounted over the primary display 814 and/or secondary display 816.

The various components of the wagering game machine 800 can be connected directly to, or contained within, the housing 812. Alternatively, some of the wagering game machine's components can be located outside of the housing 812, while being communicatively coupled with the wagering game machine 800 using any suitable wired or wireless communication technology.

The operation of the basic wagering game can be displayed to the player on the primary display 814. The primary display 814 can also display a bonus game associated with the basic wagering game. The primary display 814 can include a cathode ray tube (CRT), a high resolution liquid crystal display (LCD), a plasma display, light emitting diodes (LEDs), or any other type of display suitable for use in the wagering game machine 800. Alternatively, the primary display 814 can include a number of mechanical reels to display the outcome. In FIG. 8, the wagering game machine 800 is an “upright” version in which the primary display 814 is oriented vertically relative to the player. Alternatively, the wagering game machine can be a “slant-top” version in which the primary display 814 is slanted at about a thirty-degree angle toward the player of the wagering game machine 800. In yet another embodiment, the wagering game machine 800 can exhibit any suitable form factor, such as a free standing model, bar top model, mobile handheld model, or workstation console model.

A player begins playing a basic wagering game by making a wager via the value input device 818. The player can initiate play by using the player input device's buttons or touch screen 828. The basic game can include arranging a plurality of symbols 832 along a pay line, which indicates one or more outcomes of the basic game. Such outcomes can be randomly selected in response to player input. At least one of the outcomes, which can include any variation or combination of symbols, can trigger a bonus game.

In some embodiments, the wagering game machine 800 can also include an information reader 852, which can include a card reader, ticket reader, bar code scanner, RFID transceiver, or computer readable storage medium interface. In some embodiments, the information reader 852 can be used to award complimentary services, restore game assets, track player habits, etc.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer readable program code embodied in the medium. The described embodiments may be provided as a computer program product, or software, that may include a machine-readable storage medium having stored thereon instructions, which may be used to program a computer system (or other electronic device(s)) to perform a process according to embodiments(s), whether presently described or not, because every conceivable variation is not enumerated herein. A machine readable storage medium can include any mechanism for storing or transmitting information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments, which are defined only by the appended claims. Each of the embodiments described herein are contemplated as falling within the inventive subject matter, which is set forth in the following claims.

1. A computer-implemented method comprising:
presenting wagering game content for a wagering game during a wagering game session;
projecting an image of a wagering game control onto a physical surface via a laser beam, wherein the wagering game control affects the wagering game;
detecting player interaction at a location on the physical surface where the image of the wagering game control appears;
performing a wagering game function associated with the wagering game control in response to the detecting the player interaction at the location on the physical surface; and
modifying the presenting of the wagering game content in response to the performing the wagering game function.

2. The computer-implemented method of claim 1, wherein the projecting the image of the wagering game control onto the physical surface includes projecting the image via the laser beam through air at approximately standard atmospheric conditions.

3. The computer-implemented method of claim 1, wherein detecting the player interaction at the location on the physical surface includes
projecting an invisible infrared beam at a location where the image of the wagering game control appears, and
detecting player input that interrupts the infrared beam at the location.

4. The computer-implemented method of claim 1, wherein detecting the player interaction at the location on the physical surface includes detecting a specific finger motion by a player's finger at the location on the physical surface.

5. The computer-implemented method of claim 1, wherein performing the wagering game function includes performing one or more of transacting a bet and activating the game play in response to detecting that a player's finger touches the location on the physical surface.

6. The computer-implemented method of claim 1,
wherein the projecting the image of the wagering game control onto a physical surface includes
accessing a wagering game application from a wagering game server, and
projecting an additional image of one or more wagering game elements used in the wagering game application onto the physical surface,
wherein performing the wagering game function includes determining a wagering game outcome from the wagering game server, and
wherein modifying the presenting of the wagering game content includes modifying the projecting of the additional image on the physical surface based on the wagering game outcome.

7. The computer-implemented method of claim 1 further comprising:
detecting an additional player interaction that authorizes the player interaction; and
performing the wagering game function based on the combination of the player interaction and the additional player interaction.

8. The computer-implemented method of claim 1, wherein the physical surface is on a flatted portion of one or more of a wagering game machine, a fixture associated with of a wagering game machine, a chair of a wagering game machine, and a station at an electronic wagering game table.

9. One or more machine-readable storage media having instructions stored thereon, which when executed by a set of one or more processors causes the set of one or more processors to perform operations comprising:
initiating a wagering game session;
accessing wagering game content associated with the wagering game session;
projecting an image of the wagering game content via a laser beam, through air, onto a physical surface, during the wagering game session;
detecting a physical object in proximity to the physical surface;
detecting one or more physical attributes of the physical object; and
modifying the projecting of the image of the wagering game content based on the one or more physical attributes of the physical object.

10. The one or more machine-readable storage media of claim 9, said operations further comprising projecting the image of the wagering game content onto the physical surface to have three-dimensional characteristics.

11. The one or more machine-readable storage media of claim 9, said operations further comprising:
making the image appear to interact with the physical object in accordance with one or more physical dimensions of the physical object.

12. The one or more machine-readable storage media of claim 9, wherein the physical object is a player card associated with a player account, and said operations further comprising
detecting movement of the player card in relation to the physical surface, and
controlling access to the wagering game, by a wagering game player account, based on the movement of the player card.

13. The one or more machine-readable storage media of claim 9, said operations further comprising:
detecting player interaction with the image via the physical object, and
modifying the projecting of the image in response to the player interaction.

14. The one or more machine-readable storage media of claim 9, said operations further comprising
detecting a change in a condition of the physical object that occurs from player interaction with the physical object; and
controlling a wagering game function using the change in the condition of the physical object.

15. The one or more machine-readable storage media of claim 9, wherein the operation for detecting the one or more physical attributes of the physical object include operations further comprising:
scanning a code presented on the physical object, wherein the code is associated with an amount of money available for use during the wagering game session via a financial account; and
adding the amount of money to a wagering game session balance in response to the scanning the code.

16. A system comprising:
a wagering game controller configured to provide wagering game content;
an account server configured to provide player information associated with a wagering game player account; and
a gaming projection device configured to
receive the wagering game content from the wagering game controller,
generate a light beam from one or more projectors,
project the light beam through air onto a location on a physical surface that can reflect the light beam,
present images of the wagering game content, using the light beam, on the physical surface,
receive the player information from the account server, and
modify presentation of the wagering game content based on the player information.

17. The system of claim 16, wherein the wagering game content includes a first of the images representing a first wagering game content object and a second of the images representing a second wagering game content object, and wherein the gaming projection device is further configured to
determine from the player information a player preference for a first wagering game content object, and
present the first of the images larger in size than the second of the images based on the player preference for the first wagering game content object.

18. The system of claim 16, wherein the gaming projection device is further configured to
determine a value associated with the wagering game content, and
modify presentation of some characteristics of the images according to the value associated with the wagering game content.

19. The system of claim 16, wherein the gaming projection device is attached to a fixture, wherein a wagering game player can interact with the wagering game content on the physical surface, and wherein the gaming projection device and is further configured to present the graphical projection on a flat portion of the fixture.

20. An apparatus comprising:
a gaming projection module configured to
project wagering game content during a wagering game session,
project a graphical image of a session balance for the wagering game content onto a playing surface of a playing station using a projected beam of light,
detect a physical object in proximity to the physical surface,
scan information presented on the physical object, wherein the information identifies an amount of money available for use during the wagering game session,
add an amount of money to a wagering game session balance in response to scanning the information, and
modify a presentation of the information on the physical object using the projected beam of light, indicating that the amount of money has been used.

21. The apparatus of claim 20, wherein the gaming projection module is configured to
scan a barcode on the physical object using a laser beam, wherein the bar code indicates a unique identification value;
determine the unique identification value from the barcode, and
present an indicator on the physical object, using the laser beam, of an amount of money associated with the unique identification value.

22. The apparatus of claim 20, wherein the gaming projection module is configured to present an image on the physical object that indicates the amount of money.

23. An apparatus comprising:
means for initiating a wagering game session;
means for accessing wagering game content associated with the wagering game session;
means for projecting an image of the wagering game content, through air, onto one of more surfaces of a physical environment during the wagering game session, wherein the physical environment is outside of a casino;
means for detecting one or more physical attributes of the physical environment; and
means for modifying the projecting of the image of the wagering game content based on the one or more physical attributes of the physical environment.

24. The apparatus of claim 23, wherein the means for detecting the one or more physical attributes of the physical environment comprises means for detecting textural variations of the one or more surfaces, and wherein the means for modifying the projecting of the image of the wagering game content comprises means for modifying light characteristics of the image at locations of the textural variations.

25. The apparatus of claim 23, wherein the means for detecting one or more physical attributes of the physical environment comprises means for detecting changes in lighting conditions of the physical environment, and wherein the means for modifying the projecting of the image of the wagering game content comprises means for modifying a brightness of the image to in response to the changes in the lighting conditions.
